(19) United States
(12) Patent Application Publication
(10) Pub. No.: US 2008/0005726 A1
(43) Pub. Date: Jan. 3, 2008

(54) Methods and systems for modifying software applications to implement memory allocation

(76) Inventor: Jean-Francois Collard, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/477,840

(22) Filed: Jun. 29, 2006

(51) Int. Cl. G06F 9/45

(52) U.S. Cl. 717/153

(57) ABSTRACT

Techniques for modifying applications to implement memory allocation are disclosed. The application is executed using a default memory allocation scheme. A log is generated that identifies which memory addresses are requested by which instructions of the application. The log is evaluated to identify changes to be made to the default memory allocation scheme and, after execution, the application is modified by adding instructions to implement the identified changes.

### RELATED APPLICATION

The present application is related to U.S. patent application Ser. No. 11/030,938, entitled “Methods and Systems for Associating System Events with Program Instructions”, filed on Jan. 7, 2005 to Jean-Francois Collard, the disclosure of which is incorporated here by reference.

### BACKGROUND

The present invention relates generally to programming techniques and systems and, more particularly, to programming techniques and systems which modify software application to implement memory allocation.

The power of computers to process data continues to grow at a rapid pace. As computing power increases, software applications which are developed for new computing platforms become more sophisticated and more complex. It is not uncommon for teams of software developers to develop applications having hundreds of thousands, or even millions, of lines of software code. Similarly, the hardware used to execute such programs has become more complex. Systems with a large number of parallel processors operating in conjunction with various memory devices, interconnects and I/O devices have become more commonplace. As systems have increased in complexity, increases in processing speeds have required consideration of the relationship between processor speeds and memory access speeds. In the 1960's and 70's, one memory device could support several processors. However, as processor speeds increased more rapidly than memory access speeds, this became problematic. By providing each processor with its own, local memory device, so-called cc-NUMA (cache coherent non-uniform memory access) multiprocessor systems attempt to avoid the processing performance hit which would otherwise result when multiple processors attempt to access the same memory location.

One task performed by such multiprocessor systems is memory allocation. Memory allocation refers to the act of an operating system to determine the particular physical memory locations which are assigned to store particular program elements (e.g., variables, code and/or data). Memory is frequently allocated in chunks referred to as “pages” (the size of which may vary from system to system), so this system task is sometimes also referred to as page allocation. Suboptimal allocation of memory pages by an operating system can create a performance bottleneck, since references by a processor to a page of memory located at a distant memory device may take a long time (relative to processor speed) to be serviced.

Consider, for example, the exemplary multiprocessor system illustrated in FIG. 1. Therein, four processors P1, P2, P3 and P4 each have a local memory device M1, M2, M3 and M4, respectively, connected thereto. The processors are able to communicate via various interconnects 100, with processors P1 and P2 being closer to one another in terms of communication delay than, e.g., processors P1 and P3. Assume that a particular program to be executed on this system uses a large array of values which are to be stored somewhere in memory. If an operating system were to allocate pages of memory to store this array into only the local memory device M1 associated with processor P1, and if processors P2 and P3 are running threads that need data from this array, then processors P2 and P3 will experience a processing delay associated with retrieving the data from processor P1's memory device M1. If, alternatively, some pages were allocated to the memory devices M2 and M3, it may be possible to reduce or eliminate this delay.

Various schemes have been used for performing memory allocation in computing systems to address this concern. One such scheme is known as round-robin allocation. In round-robin allocation, an operating system allocates pages of memory to different processors in turn, e.g., page p1 is allocated to processor P1's memory M1, page P2 is allocated to processor P2's memory M2, page p3 is allocated to processor P3's memory M3, page p4 is allocated to processor P4's memory M4, page p5 is allocated to processor P1's memory M1, etc. Although this round-robin allocation scheme has the characteristic of providing balanced page allocation, there is no guarantee that page placement will be optimal, i.e., that a particular processor that needs a page of memory the most will have that particular page stored locally.

Another page allocation scheme is known as “first touch”. The first touch page allocation scheme allocates a page of memory to the local memory device of the first processor that accesses a memory address within that particular page's range of memory addresses. This technique allocates on the principle that a processor which first accesses a particular page of memory during the execution of an application is also most likely to be the most frequent accesser of that page, making allocation of that page to that processor's local memory efficient. Referring again to FIG. 1, if processor P1 first accessed pages p1 and p3 during the execution of a particular application, while processor P3 first accessed pages p2 and p4, then pages p1 and p3 would be allocated to memory M1 and pages p2 and p4 would be allocated to memory M3 in a system operating using the first touch allocation scheme.

However, this first touch allocation scheme can be foiled by initialization code which may exist at the beginning of a program. For example, an engineering application performing complex matrix computations may first initialize all of the matrices to zero, by all processors in all cells concurrently before the primary computations associated with the engineering application begin. These initializations cause each processor to access the pages of memory in which the matrix elements reside, thereby designating processors as “first touchers” of pages of memory solely due to the initialization process without regard to whether they actually use those pages during the later computations performed by the program. This may have the effect of processors being relatively distant from the data that they access during the computation phase of the program, thereby reducing the application's performance.

One way to avoid this problem with the first touch allocation scheme is to insert, before any initialization processes in an application, page touching code that is intended to mimic the first touches of the processors which would occur after the initialization code executes. In this way, the first touch page allocation will allocate memory based on the page touching code, rather than the initialization code, in a manner which is intended to more efficiently allocate memory space. However, the page touching code has thus far required a programmer or team of programmers that manually review the program to determine how the page touching code should be written, which is both costly and slow. Moreover, it still suffers from the underlying assumption of the first touch allocation scheme, i.e., that the processor which first touches a page of memory is the most frequent accesser of that page.

### SUMMARY

According to one exemplary embodiment of the present invention, a method for modifying an application to be executed on a computer system to implement memory allocation for the application includes the steps of: executing the application using a default memory allocation scheme, generating, by the computer system, a log that identifies which memory addresses are requested by which instructions of the application, evaluating the log to identify changes to be made to the default memory allocation scheme, and modifying the application by adding instructions to implement the identified changes.

### BRIEF DESCRIPTION OF THE DRAWINGS

The accompanying drawings, which are incorporated in and constitute a part of the specification, illustrate one or more embodiments of the present invention. In the drawings:

FIG. 1 illustrates an exemplary processing system used to describe the background;

FIGS. 2(a) and 2(b) illustrate portions of an exemplary processing system including multiprocessor cells;

FIG. 3 illustrates an exemplary processing system including a plurality of multiprocessor cells in which exemplary embodiments can be implemented;

FIG. 4(a) illustrates a method for modifying an application to implement memory allocation according to an exemplary embodiment;

FIG. 4(b) depicts software and hardware modules which interact during the method of FIG. 4(a) according to an exemplary embodiment;

FIG. 5 shows an example of code associated with a software application used to illustrate how an exemplary embodiment can operate;

FIG. 6 depicts a log generated according to an exemplary embodiment;

FIG. 7 shows an exemplary portion of a processing system which provides instruction identifier processing according to an exemplary embodiment;

FIG. 8 illustrates a method for identifying changes to a default memory allocation scheme according to an exemplary embodiment; and

FIG. 9 shows an example of a modified application resulting from an exemplary embodiment of the present invention.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

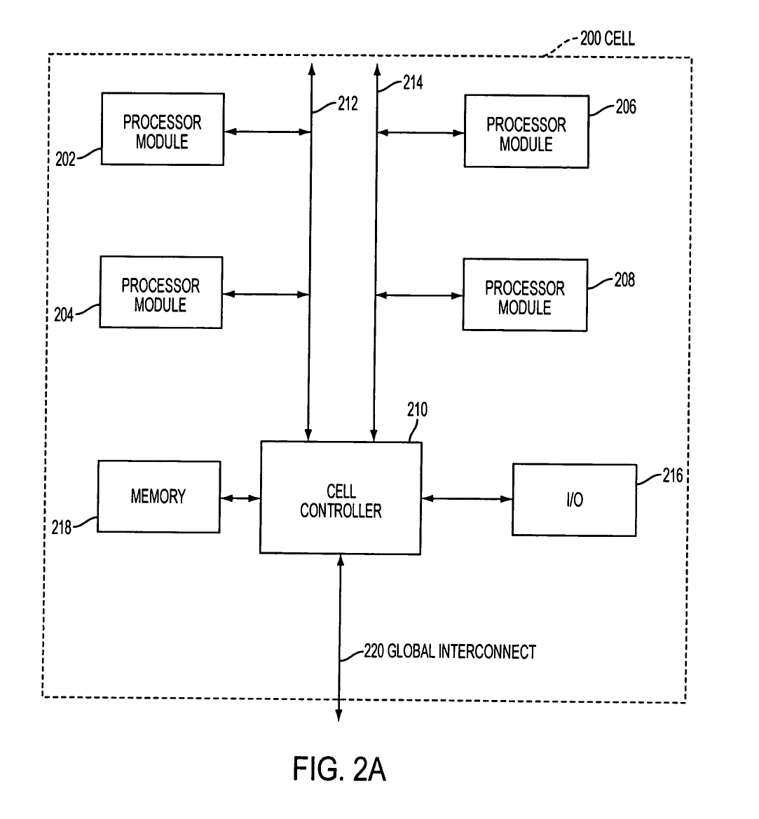

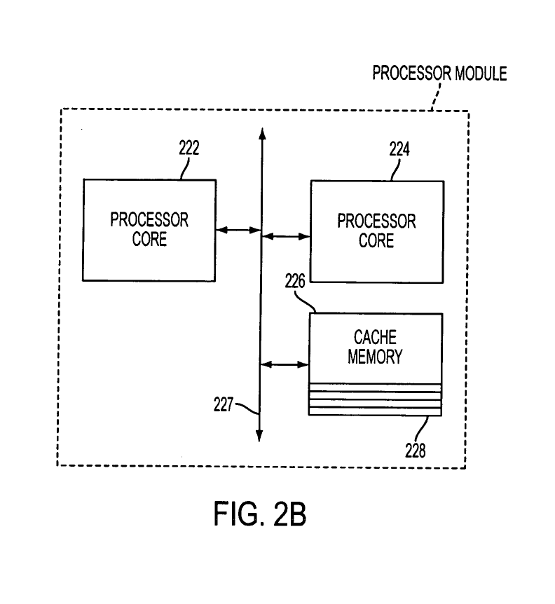

Prior to discussing techniques for modifying programs according to exemplary embodiments of the present invention, an exemplary system in which such techniques can be implemented is described below in order to provide some context. With reference to FIG. 2(a), one cell 200 of a computer system is illustrated. The cell 200 includes four processor modules 202-208 linked to a cell controller 210 via interconnects 212 and 214. Each processor module 202-208 can include, for example, two processor cores 222 and 224 and a cache memory 226 which communicate via an interconnect 227 as shown in FIG. 2(b). The cache memory 226 includes a number of cache lines 228 each of which contain an amount of information which can be replaced in the cache memory 226 at one time, e.g., one or a plurality of data words or instructions. The size of the cache lines 228 will vary in different implementations, e.g., based on the data widths of the interconnects 212, 214, 220 and 227. The cell controller 210 is connected to I/O device 216 and memory device 218, as well as to a global interconnect 220.

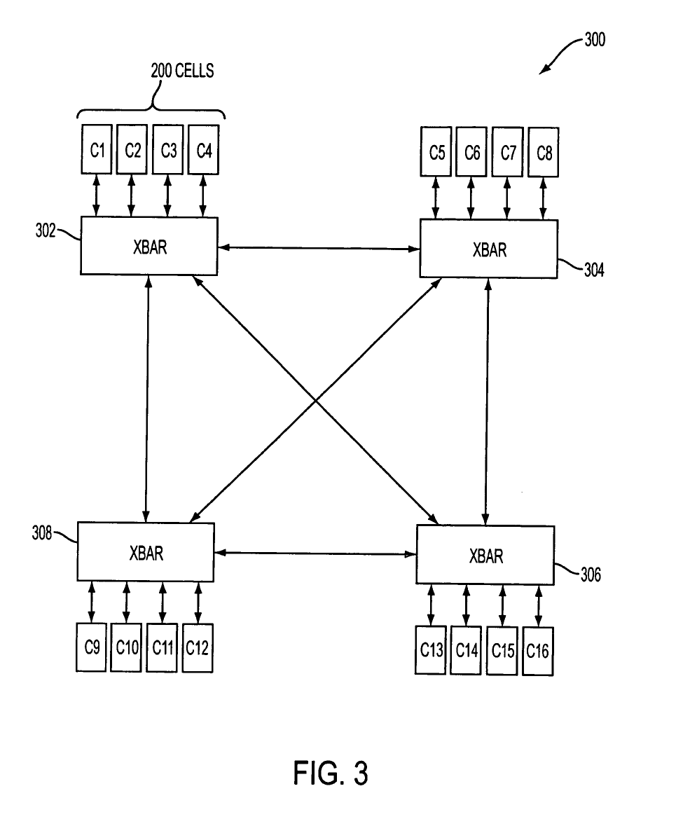

A plurality of cells 200 can be interconnected as shown in FIG. 3 to form an exemplary computer processing system 300. Therein, four cells (C) 200 are each directly connected to a respective one of the crossbar devices 302-308. It will be appreciated that the particular architectures shown in FIGS. 2(a), 2(b) and 3 are purely exemplary and that exemplary embodiments of the present invention can be implemented in processing systems having different architectures.

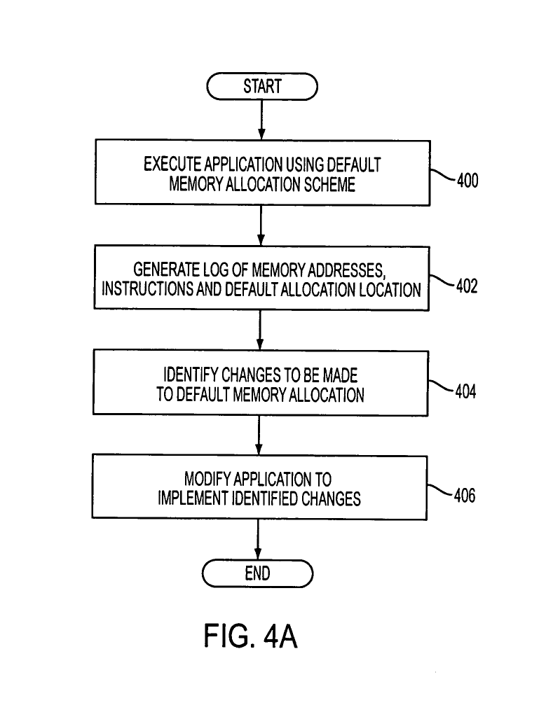

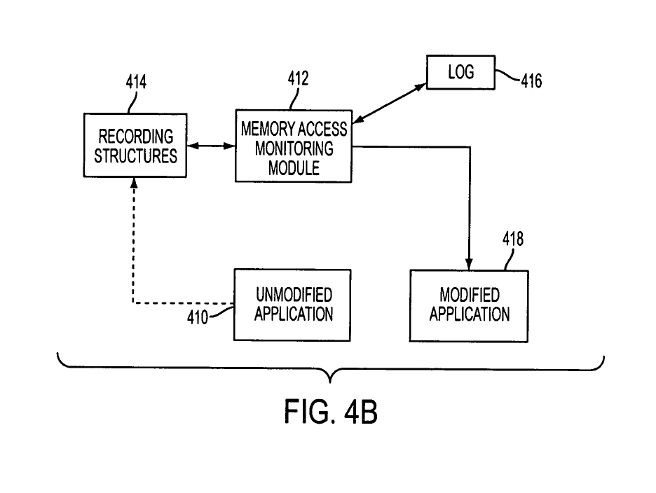

According to one exemplary embodiment of the present invention, a method for modifying an application to implement memory allocation can include the general steps illustrated in the flowchart of FIG. 4(a) and software/hardware module block diagram of FIG. 4(b). Therein, the application (program) 410 to be modified is executed in its unmodified state at step 400 using a default memory allocation scheme, e.g., a first touch memory allocation scheme, as described above. While the application is being executed under the default memory allocation scheme, the memory accesses performed by the various processors in the system are monitored by memory access monitoring module 412. More specifically, and as described in greater detail below, recording structures 414 which are, for example, local to the various processors in the system can log each memory access during execution of the unmodified application 410. The results, as noted in step 402 of the flowchart, can be retrieved by the memory access monitoring module 412 to generate a log 416 which captures data associated with each operation involving a memory address, e.g., the processor which initiated that operation and the current location at which the memory address has been allocated under the default memory allocation scheme. Next, at step 404, the log 416 can be evaluated by the memory access monitoring module 412 to identify changes which can be made to the default memory allocation scheme to, e.g., improve performance of the application during subsequent executions. Once identified, these changes are implemented by the memory access monitoring module 412 at step 406 which modifies the application 410 to implement the identified changes, e.g., by including page touching code to modify the default memory allocation scheme, to generate a modified application 418. Each of these general steps 400-406 will now be described in more detail.

In order to optimize memory allocation for a particular application to be executed on a particular computer system, that application is first executed at step 400 so that it can be monitored. Preferably, this preliminary execution of the application is performed on the same (or similar) computer system, e.g., system 300, as that which will ultimately be executing the application after the memory allocation optimization technique described herein, although this is not required. In addition, it may (optionally) be desirable to initially evaluate the application to identify those portions which are significant to the application's runtime performance so that only memory accesses associated with those portions of the application are used to determine whether changes to the default memory allocation scheme are to be made. The criteria used to identify whether a portion of a software application is “significant” in terms of runtime performance may vary. For example, a portion of software code (e.g., a loop, a loop nest or a procedure) can be designated as “significant” in terms of runtime performance if more than X percent of the application's total execution time is spent executing instructions within that portion of code, where X is a predetermined number, e.g., 30. Alternatively, each code portion can be sorted in descending order based on the amount of time spent executing that code portion by the processing system. Then, from that ranked list, the top N code portions can be selected as being “significant” in terms of runtime performance, e.g., N=3.

Regardless of which criteria is used to identify code portions as being significant or insignificant to runtime performance, the performance review can be performed manually by a programmer, e.g., to identify initialization code as a portion of an application which is not significant to the application's runtime performance, or automatically by profiling the application. Profiling an application refers to a process wherein the application is executed to generate data indicating which instructions, i.e., referenced by their program counters (or PCs), were executed the most often and/or the amount of time those instructions took to be executed. If profiling is performed, it can be performed during the execution initiated in step 400, e.g., in parallel with step 402.

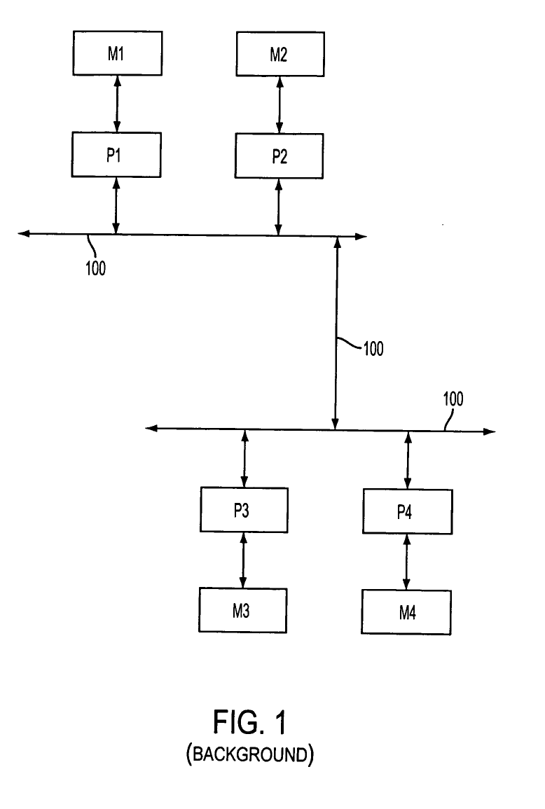

As part of step 400, the data associated with the application being modified is allocated to memory devices according to a default memory allocation scheme. The phrase “default memory allocation scheme” as it is used herein refers to the technique associated with the computer system (or operating system governing application execution) by which memory is allocated absent any intervention. Purely for the sake of illustration, the first touch memory allocation scheme described above with respect to FIG. 1 will be used here as the default memory allocation scheme to illustrate operation of this exemplary embodiment.

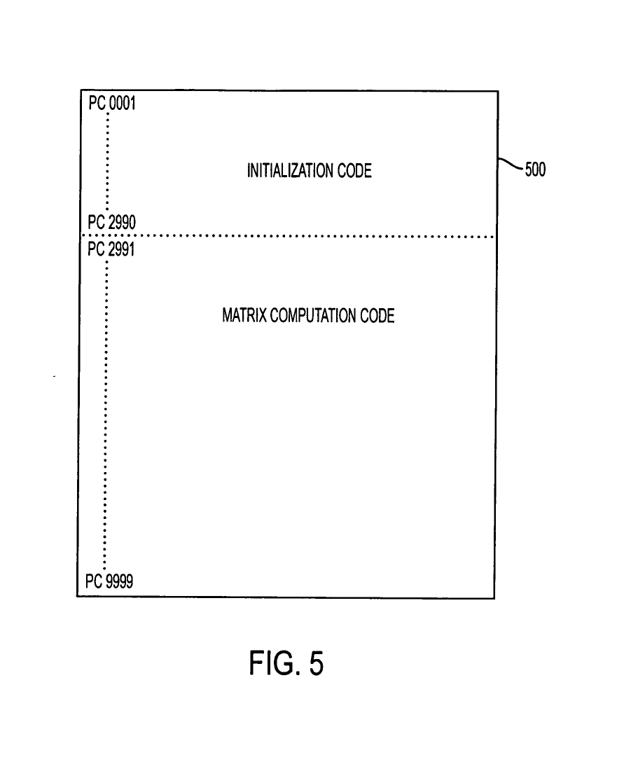

Accordingly, consider the unmodified application 500 conceptually illustrated in FIG. 5, which has some initialization code followed by a section of complex matrix computations. Each instruction in the application 500 will have associated therewith a program counter (PC) value as it is executed by the computer system 300, although only a few exemplary PC values are shown in FIG. 5. As the application 500 is executed on system 300 (as represented by step 400 of the flowchart of FIG. 4), the application is monitored to gather information (as represented by step 402) which can then be used to change the default memory allocation scheme. More specifically, exemplary embodiments of the present invention will generate a log which will indicate, for example, which memory addresses are requested by which instructions by tracking the PCs of the instructions which request memory accesses of the unmodified application 500, and where those memory addresses reside as a result of the default memory allocation scheme. In this context, the term “log” refers generically to any type of data structure, list, table or the like which can be generated by computer system 300 to provide access to this type of information.

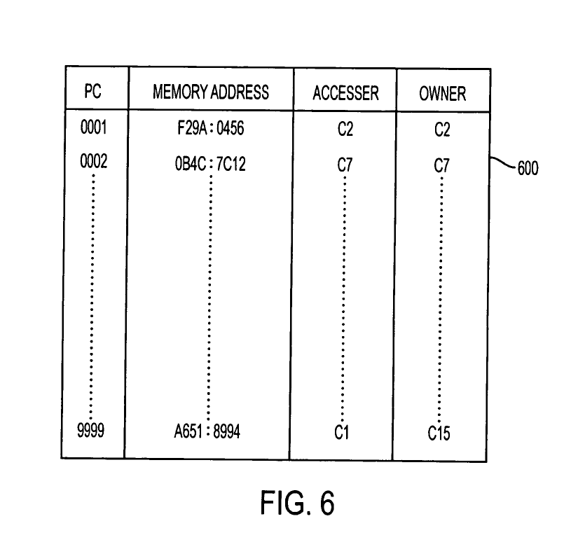

FIG. 6 depicts an exemplary log 600 which can be generated during step 402 by memory access monitoring module 412. Therein, each row provides a correlation between a PC value of an instruction causing a memory access, the particular memory address that has been accessed, the cell (or processor) requesting the access and the owner of the memory page being accessed. The owner of the memory page being accessed in log 600 is determined based upon the default memory allocation scheme. Since, in this example, the operating system running on computer system 300 employs the first touch allocation scheme as the default memory allocation scheme, the first two memory accesses which are stored in log 600 list the accesser as also being the owner of the relevant page.

In some systems, memory accesses may be performed by system components (e.g., video subsystems, main memory, secondary memories, etc.) which do not have direct access to the PC values or processor identities associated with the instruction which is generating the access. According to exemplary embodiments of the present invention, the logging of data like that illustrated in FIG. 6 is facilitated by sending instruction identifier information along with the instructions themselves which are submitted for processing within the system 300. For example, system-wide event monitoring can be facilitated via instruction identifier information to use the capabilities of both the processors and other system components. The instruction identifier may include a value associated with the instruction from the program counter, identification of the processor submitting the instruction, identification of the thread corresponding to the instruction or any combination thereof. Identification of the thread may be useful as multiple threads may be executing simultaneously on a processor.

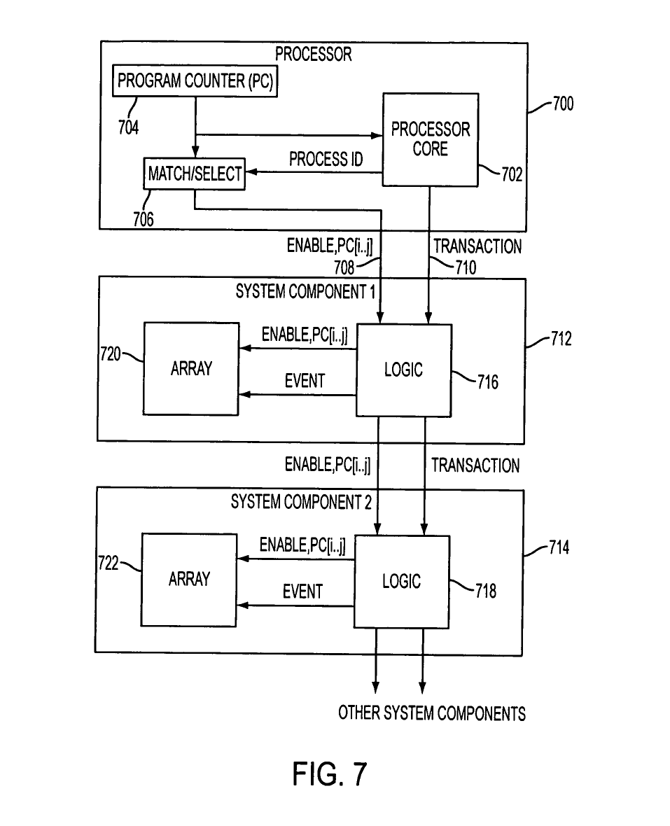

FIG. 7 illustrates one exemplary structure and technique for providing instruction identifier information during the preliminary execution of the unmodified program in order to capture data associated with memory accesses. Therein, a processor 700 includes a processor core 702, a program counter (PC) 704 and, optionally, a match/select function 706. The match/select function 706 receives, as inputs, PC values from the program counter 704 and, optionally, a process ID from the processor core 702. Based on these inputs, the match/select function 706 can selectively generate an enable signal when a PC value received from the program counter 704 is within a predetermined range and/or when the process ID is a process of interest for monitoring purposes, e.g., for those portions of the unmodified program which have been determined a priori to be significant to runtime execution as described above.

In addition to an enable signal, the match/select function 706 can also output a specified subset of the PC value bits, denoted PC[i . . . j] in FIG. 7, on interconnect 708 (which may for instance be a bus). The specified range of PC values which result in an enable condition, the specified subset of PC value bits to be output on the interconnect 708 and/or the ID of the process of interest can all be dynamically programmed into the match/select function 706 by the processor core 702 or any other processor/intelligence in the system. The enable and PC[i . . . j] signals transmitted by the match/select function 706 are then associated with a corresponding transaction generated by the processor core 702 that is transmitted on interconnect 710 to system components 712 and 714. It will be appreciated that more than two system components can be associated with the system of FIG. 7.

The system components 712 and 714 each have logic blocks 716 and 718 associated therewith, respectively. Logic blocks 716 and 718 receive the transactions emitted by processor core 702. Logic blocks 716 and 718 can recognize memory accesses that occur while performing the operation indicated by the received transaction. If a memory access occurs, the logic block associated with the system component wherein the memory access takes place can generate an output. The output can, for example, be a memory page identifier.

As seen in FIG. 7, the system components 712 and 714 also include arrays 720 and 722, respectively, as recording structures 414 in this exemplary embodiment. When a memory access occurs, the associated array receives the memory page identifier from the respective logic block, the enable signal as well as the PC values from its respective logic block. The array 720 or 722 stores these outputs, or parts thereof, for later processing, e.g., access by the memory access monitoring module 412 for creation of a log. Those skilled in the art will appreciate that the use of instruction identifiers in conjunction with exemplary embodiments of the present invention can take many other forms than that described herein and that these instruction identifiers enables the log to include information about which program statement accessed which memory location in which cell (or node)

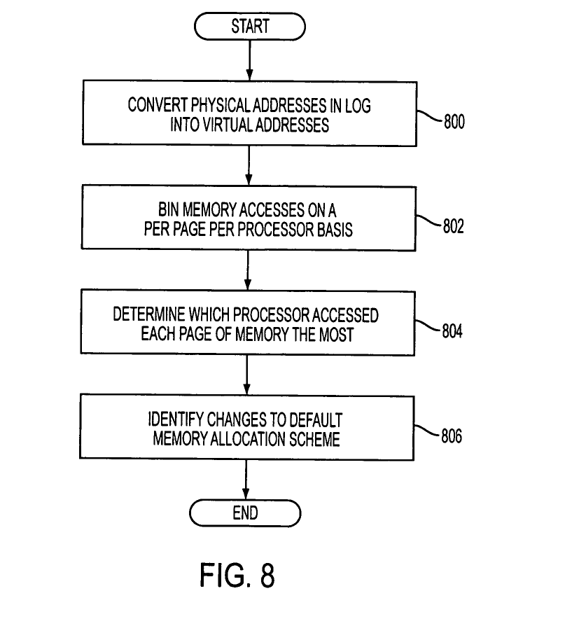

Once the log 600 has been generated, it is then evaluated at step 404 of the flowchart of FIG. 4 to identify potential changes to the default memory allocation scheme. An exemplary evaluation process is illustrated in the flowchart of FIG. 8. Therein, at step 800, the addresses stored in the log 600 are converted from physical addresses into virtual addresses using, e.g., a function call made available by the operating system. Next, at step 802, a binning process is performed to count each processor's (or each cell's) access to each page of memory found in the log 600. This can be implemented, for example, using a counter for each memory page for each processor (or cell). Then, each virtual address generated from step 800 is mapped to its respective page of memory and the corresponding counter is incremented for that page of memory for the accesser listed in the log 600. Note that if the optional profiling step described above is used, then memory accesses associated with those portions of the application which are less significant to the performance of the application can be omitted from the binning step 802. After the binning is completed, then the counters can be checked to determine, at step 804, which processor (or cell) accessed each page of memory the most. That processor (or cell) can then be designated as the preferred owner of that page of memory. If the preferred owner differs from the owner under the default memory allocation scheme, then a change is identified at step 806.

Note, however that according to other exemplary embodiments, criteria other than the most memory accesses per page can be used to determine which page of memory should be allocated to which processor (or cell). For example, a metric associated with minimizing the total number of hops associated with accessing a page of memory could be used instead. Referring to FIG. 3, suppose that it was determined that although cell C1 accessed memory page p1 the greatest number of times during the execution of the application (e.g., 5000) times on a per cell basis, that the cluster of cells C1-C4 cumulatively accessed page p1 10000 times while the cluster of cells C13-C16 cumulatively accessed page p1 11000 times. Under such circumstances a hop minimization criteria might determine that one of the cells C13-C16 should be the owner of page p1 even though it did not access page p1 more times than cell C1.

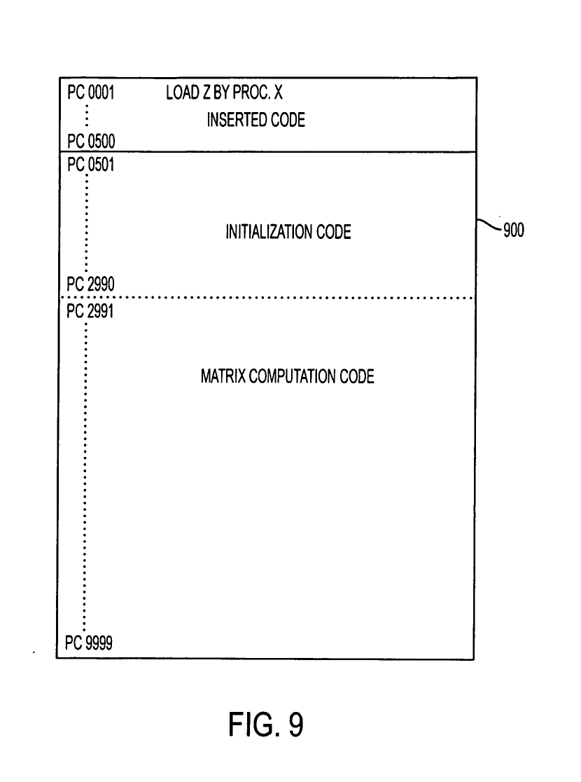

Returning to the flow chart of FIG. 4(a), once changes to the default memory allocation scheme have been identified, the flow proceeds to step 406 wherein the application is modified to implement the identified changes. This can be performed in any of a number of ways, however according to one exemplary embodiment the end result is that a line of page touching code is inserted in the application for each identified change to the default memory allocation scheme. Consider the following example with reference again to the log 600 in FIG. 6. Suppose that, after evaluation of the log 600 pursuant to the exemplary steps illustrated in FIG. 8, it is determined that the page containing memory address F29A:0456 should be allocated to cell C3 instead of cell C2. Then, at step 406, a line of code will be inserted into the application which causes one of the processors associated with cell C2 to access a memory location within that page of memory. For example, a LOAD command instructing that a particular processor X in cell C3 access an element Z of a data structure within that particular page of memory can be inserted into the application at the beginning thereof. Other instructions can be added to implement other changes identified at step 806. An example of a modified version 900 of the application 500 is shown in FIG. 9.

In this way, when the modified application is executed subsequent to step 406, the pages will be allocated based upon the default allocation scheme which has been modified by page touching code which has been inserted into the application based upon an actual evaluation of the application's execution in an automated manner.

Various modifications and permutations on the foregoing exemplary embodiments are contemplated. For example, the step associated with identifying changes to the default memory allocation scheme may include both determining if a page of memory was allocated by the default memory allocation scheme to a processor other than the processor which accessed that page a maximum number of times and if the processor which accessed that page a maximum number of times is not local to the processor to which that page was allocated by said default memory allocation scheme. The additional non-locality criteria may be useful in cc:NUMA systems because it facilitates a reduction in requests passing through crossbar circuitry. Consider again the exemplary processing system of FIG. 3. Therein, the processors within each cell can be said to be neighbors. A memory request initiated in Cell C1 and serviced by Cell C1 is cheap (from a latency/bandwidth point of view) and may be disregarded for the purposes of determining whether to change a default memory allocation scheme according to some exemplary embodiments of the present invention. On the other hand, a memory request initiated by Cell C1 and serviced by memory in Cell C2 is non local; it takes more time because one crossbar (Xbar) 302 needs to be traversed. If the request goes from cell C1 to Cell C5, the request is even more expansive. Thus, according to exemplary embodiments, it may be desirable to minimize requests going though 2 crossbars first, then minimize those going through a single crossbar, as part of the processing for determining changes to the default memory allocation scheme. Alternatively, if N2 and N1 are the costs (in time) of going through 2 or 1 crossbars, respectively, and X2 and X1 are the numbers of such requests which are determined from the log, then it may be desirable to minimize X2*N2+X1*N1.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

Thus, according to one exemplary embodiment of the present invention, a default memory allocation scheme is a first touch scheme. After analyzing the unmodified software application in the manner described above, store and/or load instructions are inserted into a beginning portion of the software application. The store and/or load instructions contain addresses which are selected based upon changes to the default memory allocation scheme that have been identified as a result of the analysis. Thus, theses addresses will vary at each processor (or each cell if only non-local processors are considered as described above), such that each processor or cell will touch certain pages of memory to enforce allocation of that memory portion to that processor or cell, e.g., before executing initialization code.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for modifying an application to be executed on a computer system to implement memory allocation for said application, the method comprising the steps of:
executing said application using a default memory allocation scheme;
generating, by said computer system, a log that identifies which memory addresses are requested by which instructions of said application;
evaluating said log to identify changes to be made to said default memory allocation scheme; and
after executing said application, modifying said application by adding instructions to a beginning portion of said application to implement said identified changes.

2. The method of claim 1 wherein said default memory allocation scheme is a first touch memory allocation scheme.

3. The method of claim 1, wherein said step of generating, by said computer system, said log further comprises the steps of:
submitting an instruction from a first processor associated with said computer system to a second processor associated with said computer system;
submitting an instruction identifier by the first processor along with said instruction;
detecting a memory access by said second processor during execution of the instruction; and
recording the memory access and said instruction identifier.

4. The method of claim 3 wherein the instruction identifier includes contents of a program counter and an identification of the first processor.

5. The method of claim 1, wherein said step of evaluating said log to identify changes to be made to said default memory allocation scheme further comprises the steps of:
using said log to determine a number of times each processor in said computer system accesses a page of memory during said executing step; and
determining whether said page of memory was allocated, by said default memory allocation scheme, to a processor which accessed said page a maximum number of times during said executing step; and
selectively identifying a change to said default memory allocation scheme for said page based on said determining step.

6. The method of claim 5, wherein said step of selectively identifying a change to said default memory allocation scheme for said page further comprises the step of:
identifying a change to said default memory allocation scheme for said page if said page was allocated by said default memory allocation scheme to a processor other than said processor which accessed said page a maximum number of times and if said processor which accessed said page a maximum number of times is not local to said processor to which said page was allocated by said default memory allocation scheme.

7. The method of claim 1 wherein said step of modifying said application by adding instructions to implement said identified changes further comprises the step of:
adding instructions to said application, each of which accesses a page of memory by a processor to which said page is to be allocated in a modified version of said application.

8. The method of claim 1 further comprising the step of:
determining which portions of said application are significant for runtime performance of said application;
wherein said step of generating said log involves only those instructions within said portions of said application.

9. The method of claim 1, wherein said memory addresses in said log are virtual addresses and wherein said step of evaluating further comprises the step of:
converting said virtual addresses in said log into physical addresses.

10. A computer-readable medium containing instructions which, when executed on a computer, perform the steps of:
executing said application using a default memory allocation scheme;
generating, by said computer system, a log that identifies which memory addresses are requested by which instructions of said application;
evaluating said log to identify changes to be made to said default memory allocation scheme; and
after executing said application, modifying said application by adding instructions to a beginning portion of said application to implement said identified changes.

11. The computer-readable medium of claim 10 wherein said default memory allocation scheme is a first touch memory allocation scheme.

12. The computer-readable medium of claim 10, wherein said step of generating, by said computer system, said log further comprises the steps of:
submitting an instruction from a first processor associated with said computer system to a second processor associated with said computer system;
submitting an instruction identifier by the first processor along with said instruction;
detecting a memory access by said second processor during execution of the instruction; and
recording the memory access and said instruction identifier.

13. The computer-readable medium of claim 12 wherein the instruction identifier includes contents of a program counter, an identification of the processor and an identification of a thread which is executing the instruction.

14. The computer-readable medium of claim 10, wherein said step of evaluating said log to identify changes to be made to said default memory allocation further comprises the steps of:
using said log to determine a number of times each processor in said computer system accesses a page of memory during said executing step; and
determining whether said page of memory was allocated, by said default memory allocation scheme, to a processor which accessed said page a maximum number of times during said executing step; and
selectively identifying a change to said default memory allocation scheme for said page based on said determining step.

15. The computer-readable medium of claim 14, wherein said step of selectively identifying a change to said default memory allocation scheme for said page further comprises the step of:
identifying a change to said default memory allocation scheme for said page if said page was allocated by said default memory allocation scheme to a processor other than said processor which accessed said page a maximum number of times and if said processor which accessed said page a maximum number of times is not local to said processor to which said page was allocated by said default memory allocation scheme.

16. The computer-readable medium of claim 10 wherein said step of modifying said application by adding instructions to implement said identified changes further comprises the step of:
adding instructions to said application, each of which accesses a page of memory by a processor to which said page is to be allocated in a modified version of said application.

17. The computer-readable medium of claim 10 further comprising the step of:
determining which portions of said application are significant for runtime performance of said application;
wherein said step of generating said log involves only those instructions within said portions of said application.

18. The computer-readable medium of claim 10, wherein said memory addresses in said log are virtual addresses and wherein said step of evaluating further comprises the step of:
converting said virtual addresses in said log into physical addresses.

19. A system for modifying a software application comprising:
means for executing said application using a default memory allocation scheme;
means for generating, by said computer system, a log that identifies which memory addresses are requested by which instructions of said application;
means for evaluating said log to identify changes to be made to said default memory allocation; and
means for, after executing said application, modifying said application by adding instructions to a beginning portion of said application to implement said identified changes.

20. The method of claim 7, wherein said default memory allocation scheme is a first touch memory allocation scheme, said added instructions are at least one of store and load instructions, which added instructions are inserted into said application prior to a first instruction in an unmodified version of said application, and further wherein addresses referenced in each of the added instructions vary at each processor or cell in said computer system.

21. The computer-readable medium of claim 16, wherein said default memory allocation scheme is a first touch memory allocation scheme, said added instructions are at least one of store and load instructions, which added instructions are inserted into said application prior to a first instruction in an unmodified version of said application, and further wherein addresses referenced in each of the added instructions vary at each processor or cell in said computer system.
